(19) United States
(12) Patent Application Publication
(10) Pub. No.: US 2013/0205377 A1
(43) Pub. Date: Aug. 8, 2013

(54) METHODS USING BIOMETRIC CHARACTERISTICS TO FACILITATE ACCESS OF WEB SERVICES

(71) Applicant: Yiou-Wen Cheng, Hsinchu City (TW)

(72) Inventor: Yiou-Wen Cheng, Hsinchu City (TW)

(21) Appl. No.: 13/365,267

(22) Filed: Feb. 3, 2012

(51) Int. Cl. G06F 21/00

(52) U.S. Cl. 726/7

(57) ABSTRACT

Methods for facilitating access of a web service are provided. In an embodiment, a first web device first obtains at least one reference biometric characteristic. Then, the first web device receives at least one parameter for the web service. Next, the first web device associates the at least one reference biometric characteristic with the at least one parameter. Thereafter, a second web device obtains at least one biometric characteristic. Then, the at least one biometric characteristic obtained by the second web device is compared with the at least one reference biometric characteristic. If the at least one biometric characteristic obtained by the second web device matches the at least one reference biometric characteristic, the second web device applies the at least one parameter to the web service.

### BACKGROUND

The invention relates generally to the access of web services, and more particularly, to the use of biometric characteristics to facilitate the access of web services.

Web services are provided through the Internet. Nowadays there are countless web services available to Internet users. Examples of the most popular web services include social network services such as Facebook, Twitter, and Google+, on-demand video services such as YouTube, Hulu, and Netflix, and real-time communication services such as Windows Live Messenger, Google Talk, and Skype.

At least at the time when this application is filed, many Internet users still uses their computers, such as personal computers (PCs) and notebook computers (NBs), to access web services. However, some of the Internet users have already started using other electronic devices that are connected to the Internet to access web services. Examples of these electronic devices include tablet computers, smart phones, media players, internet protocol televisions (IPTVs), set-top boxes (STBs), and video game consoles of Xbox and Wii. For the sake of simplicity, electronic devices that can be used to access web services will be collectively referred to as “web devices” in the following disclosure.

It is expected that in the foreseeable future more and more people will use web devices other than PCs and NBs to access web services, and such use will become more frequent. However, the user input interfaces of most web devices other than PCs and NBs are quite inconvenient, especially when these interfaces are compared with the keyboards and pointing devices (such as mice, touchpads, and track points) of PCs and NBs. Example of these relatively less convenient user input interfaces include touch screens, small keypads, and remote controls. It is relatively more difficult and time-consuming for a user to use one of these interfaces to input login information and user settings. This inconvenience is one of the main factors that are hampering the use of web devices (other than PCs and NBs) to access web services from growing popular.

### SUMMARY

One of the objectives of the embodiments of the invention is to facilitate a person's use of a web device to access a web service, especially when the web device does not have a convenient input interface. Another of the objectives is to save the person's time and effort that would have been spent on inputting the same information for the same web service repetitively on different web devices.

In an embodiment, a first web device first obtains at least one reference biometric characteristic. Then, the first web device receives at least one parameter for the web service. Next, the first web device associates the at least one reference biometric characteristic with the at least one parameter. Thereafter, a second web device obtains at least one biometric characteristic. Then, the at least one biometric characteristic obtained by the second web device is compared with the at least one reference biometric characteristic. If the at least one biometric characteristic obtained by the second web device matches the at least one reference biometric characteristic, the second web device applies the at least one parameter to the web service.

In another embodiment, a first web device first obtains at least one reference biometric characteristic. Then, the first web device receives at least one parameter for the web service. Next, the first web device associates the at least one reference biometric characteristic with the at least one parameter. Thereafter, at least one biometric characteristic is received from a second web device. Then, the at least one biometric characteristic received from the second web device is compared with the at least one reference biometric characteristic. If the at least one biometric characteristic received from the second web device matches the at least one reference biometric characteristic, the at least one parameter is sent to the second web device.

In still another embodiment, at least one reference biometric characteristic and at least one parameter are received from a first web device. Thereafter, a second web device obtains at least one biometric characteristic. Then, the at least one biometric characteristic obtained by the second web device is compared with the at least one reference biometric characteristic. If the at least one biometric characteristic obtained by the second web device matches the at least one reference biometric characteristic, the second web device applies the at least one parameter to the web service.

In yet another embodiment, a server receives at least one reference biometric characteristic and at least one parameter from a first web device. Next, the server receives at least one biometric characteristic from a second web device. Then, the server compares the at least one biometric characteristic received from the second web device with the at least one reference biometric characteristic. If the at least one biometric characteristic received from the second web device matches the at least one reference biometric characteristic, the server sends the at least one parameter to the second web device.

In still another embodiment, a web device first obtains at least one biometric characteristic. Then, the web device sends out the at least one biometric characteristic to query for at least one parameter. Next, the web device receives the at least one parameter corresponding to the at least one biometric characteristic. Thereafter, the web device applies the at least one parameter to a web service.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 and FIG. 4 are schematic diagrams of systems according to two embodiments of the invention.

FIG. 2 and FIG. 3 are flowcharts of two exemplary processes performed by the system shown in FIG. 1.

FIG. 5 is a flowchart of an exemplary process performed by the system shown in FIG. 4.

### DETAILED DESCRIPTION

This detailed description introduces several embodiments of the invention. For the sake of simplicity, each of these illustrated embodiments involves only a web service, two web devices, and one common or two different users. Without departing from the spirit and scope of the invention, any of these embodiments can be modified to accommodate to more web services, more web devices, and/or more users. In making the modifications, information security is an important concern that needs to be taken care of.

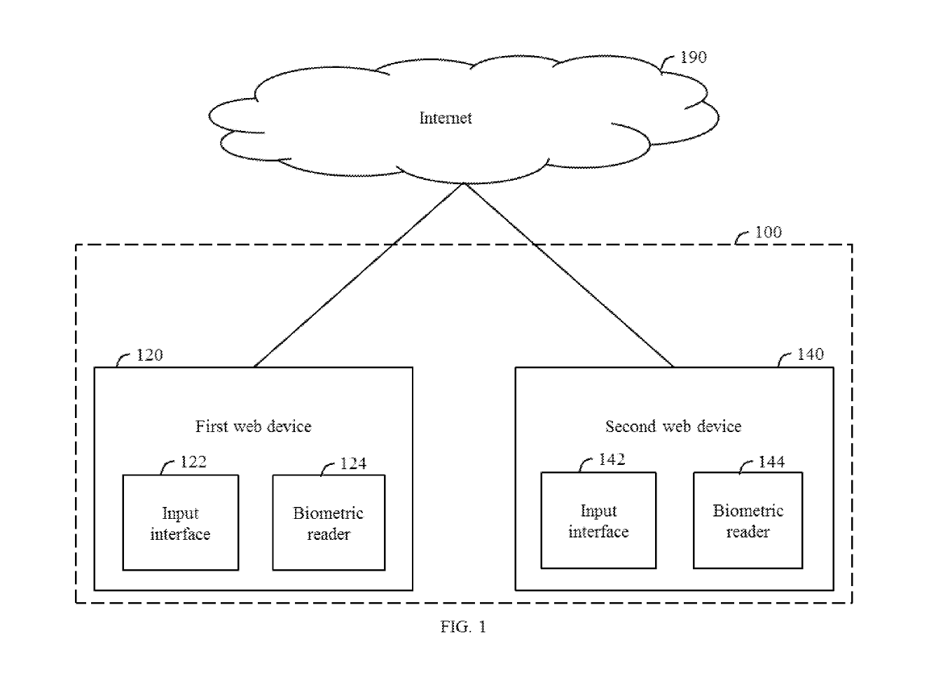

FIG. 1 is a schematic diagram of a system according to an embodiment of the invention. For the sake of simplicity, devices and components that are either unrelated to or only tangentially related to the invention are omitted from FIG. 1.

The system 100 of this embodiment includes a first web device 120 and a second web device 140, both of which can be connected to the Internet 190. The first web device 120 and the second web device 140 are what users can use to access web services that are provided through the Internet 190.

In this embodiment, the first and second web devices 120 and 140 need to communicate with each other. For example, if the two devices 120 and 140 are within the same local area network (LAN), they may communicate with each other through the LAN. If the two devices 120 and 140 are not within the same LAN, they may communicate with each other through the Internet 190. To protect private information from being intercepted by other unauthorized devices, the embodiment may adopt some means to ensure information security. Information security is important especially when the first and second web devices 120 and 140 exchange some private information through the Internet 190.

For the first and second web devices 120 and 140 to communicate with each other, they may need to know each other's address. For example, they may use broadcast/multicast packets to look for web devices that are compatible with the embodiment. As another example, a common user of these two devices 120 and 140 can set these two devices manually to help them locate each other.

The first web device 120 has an input interface 122 and a biometric reader 124. Although these two components are depicted as integral parts of the first web device 120, either one (or both) of them can be a stand-alone and detachable component that is connected to the first web device 120. The input interface 122 allows the first web device 120 to receive inputs from a user. The biometric reader 124 allows the first web device 120 to obtain at least one biometric characteristic from that user. The obtained biometric characteristic(s) include one or more biometric characteristics that are unique to the user and are unlikely to be possessed by another person; hence can be used for identification purposes. A biometric characteristic can be either a physiological one or a behavioral one; examples of the biometric characteristics include a fingerprint, a palm print, a vein pattern, a facial feature, a retinal/iris feature, and a voice pattern. These characteristics serve as examples only; other kinds of biometric characteristics can also be used in the embodiments of the invention. To read the biometric characteristic(s), the biometric reader 124 may need to include a scanner, a camera, a microphone, or a combination thereof.

Similar to the first web device 120, the second web device 140 also has an input interface 142 and a biometric reader 144. Although these two components are depicted as integral parts of the second web device 140, either one (or both) of them can be a stand-alone and detachable component that is connected to the second web device 140. To reduce hardware cost, a single detachable component can be used to realize the biometric reader 124 when being connected to the first web device 120, and realize the biometric reader 144 when being connected to the second web device 140.

The input interface 142 allows the second web device 140 to receive inputs from a user of the second web device 140. The biometric reader 144 allows the second web device 140 to obtain at least one biometric characteristic from the user. For example, the biometric reader 144 may include a scanner, a camera, a microphone, or a combination thereof.

The embodiment will compare the biometric characteristic(s) obtained from the user of the second web device 140 with the biometric characteristic(s) obtained from the user of the first web device 120 to determine whether the two sets of biometric characteristic(s) are obtained from the same person. Therefore, the two sets of biometric characteristic(s) should include biometric characteristic(s) of the same kind(s). For example, if the biometric characteristic obtained from the user of the first web device 120 includes only a fingerprint, then the biometric characteristic obtained from the user of the second web device 140 also has to include a fingerprint. If the biometric characteristics obtained from the user of the first web device 120 includes both a facial feature and a voice pattern, the biometric characteristics obtained from the user of the second web device 140 also has to include a facial feature and a voice pattern.

As mentioned, a user can use either the first web device 120 or the second web device 140 to access the web service. But when it comes to inputting date, e.g. inputting letters, symbols, numbers, or a combination thereof, it may be more convenient for the user to use one of the two interfaces than the other. Although the embodiment is useful regardless of whether the convenience levels of the input interfaces 122 and 142 are different, the embodiment is especially valuable when the input interface 122 is more convenient than the input interface 142. For example, the input interface 122 may be more convenient than the input interface 142 if the former includes a keyboard and a pointing device (such as a mouse, a touchpad, or a track point), while the latter includes only a touch screen, a small keypad, or a remote control.

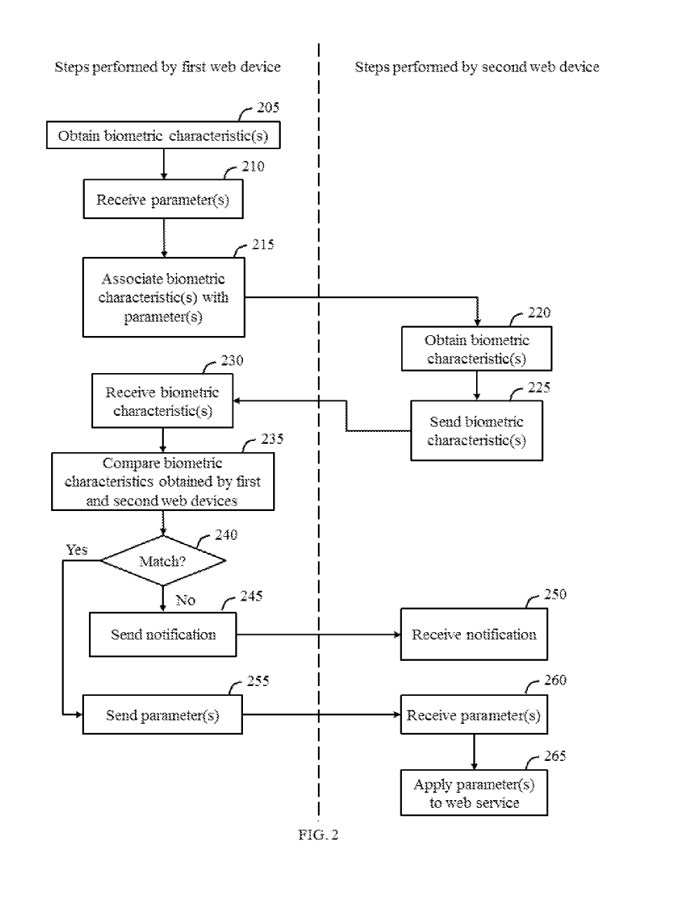

FIG. 2 is a flowchart of an exemplary process performed by the system 100 shown in FIG. 1. For the sake of simplicity, only the steps that are directly related to the invention are depicted in FIG. 2.

At step 205, the first web device 120 uses the biometric reader 124 to obtain a first set of at least one biometric characteristic from the first web device 120′s current user. At step 210, the first web device 120 uses the input interface 122 to receive a set of at least one parameter for the web service. The set of parameter(s) may include a username and a password the user uses to login to the web service on the first web device 120. The set of parameter(s) may also include a setting the user wants to apply to the web service. For example, if the web service is an on-demand video service, the set of parameter(s) may include a list of the user's favorite programs/channels, or the user's user classification.

Although step 210 follows step 205 in FIG.2, these two steps can be performed in a reverse order, or at the same time. After steps 205 and 210, the user may use the first web device 120 to access the web service; this subsequent use is not directly related to the invention and hence is omitted from the figure.

At step 215, the first web device 120 associates the first set of reference biometric characteristic(s) with the set of parameter(s). For example, this association allows the first web device 120 to apply the set of parameter(s) inputted at step 210 whenever it obtains another set of biometric characteristic(s) that matches the first set of reference biometric characteristic(s). Theoretically, this will happen if the user involved in steps 205 and 210 wants to use the first web device 120 to access the web service again. Because of the association, that user needs not repeat step 210; instead, after repeating step 205, the first web device 120 can automatically retrieve and apply the set of parameter(s) for the user. For example, if the set of parameter(s) includes a username and a password the user used to login to the web service at step 210, the first web device 120 can retrieve the username and password and login to the web service for the user automatically.

As another example, the association allows the first web device 120 to provide the set of parameter(s) inputted at step 210 to the second web device 140 whenever the second web device 140 obtains a set of biometric characteristic(s) that matches the first set of reference biometric characteristic(s). Theoretically, this will happen if the user involved in steps 205 and 210 later wants to use the second web device 140 to access the web service. Because of the association, that user needs not repeat step 210 on the second web device 140; instead, the second web device 140 can automatically find and apply the set of parameter(s) for the user.

Step 220 is performed when a person, who might be the same as or different from the person involved in steps 205 and 210, wants to use the second web device 140 to access the web service. Specifically, at step 220, the second web device 140 uses the biometric reader 144 to obtain a second set of at least one biometric characteristic from its current user.

Then, instead of asking its current user to input parameter(s), at step 225 the second web device 140 sends out the second set of biometric characteristic(s) to see if there is parameter(s) belong to the user available on a parameter server. In this example, the first web device 120 serves as the parameter server and can provide the set of parameter(s) inputted at step 210 if the second set of biometric characteristic(s) matches first set of reference biometric characteristic(s).

If the second web device 140 does not know which device is the parameter server, at step 225 it can send the second set of biometric characteristic(s) to at least one candidate parameter server, whether the at least one candidate parameter server is within the Internet 190 or a local area network (LAN) where the second web device 140 belongs to. The address(es) of the candidate parameter server(s) can be provided by the web service, be preset by a manufacturer/vender of the second web device 140, or be preset by a user/owner of the second web device 140. In another example, at step 225 the second web device 140 can broadcast or multicast the second set of biometric characteristic(s) within the aforementioned LAN, to see whether a parameter server is also within the LAN and whether the parameter server can provide the set of parameter(s) inputted at step 210.

At step 230, the first web device 120 receives the second set of biometric characteristic(s). At steps 235 and 240, the first web device 120 determines whether the person involved in step 220 is the same as the person involved in steps 205 and 210. Specifically, the first web device 120 does so by comparing the second set of biometric characteristic(s) with the first set of reference biometric characteristic(s). The first web device 120 may use an identification component, which is not depicted in FIG. 1, to perform steps 235 and 240. For example, the identification component can be a dedicated hardware component or be realized by a processor of the first web device 120.

If the first web device 120 fails to find a match, it's likely that the person who is now using the second web device 140 is different from the person who used the first web device 120 at steps 205 and 210. Then, at step 245, the first web device 120 sends the second web device 140 a notification. On the other hand, if the first web device 120 does find a match, it's likely that the person involved in steps 205 and 210 now wants to use the second web device 140 to access the web service. In response, at step 255 the first web device 120 sends the set of parameter(s) inputted at step 210 to the second web device 140.

A match between the first and second sets of biometric characteristic(s) exists if the similarity between the two sets exceeds a threshold level. The threshold level may be selected based upon some factors, such as the importance of information security under the circumstances, the number of potential users who may use the first and second web devices 120 and 140 to access the web service, and the number of biometric characteristic(s) contained in the first and second set of biometric characteristic(s). For example, if the first and second web devices 120 and 140 are within a secured home network and only a few family members will use the two devices 120 and 140 to access the web service, the threshold level needs not be very high.

At step 250, the second web device 140 receives the notification from the first web device 120. The notification indicates that the first web device 120 does not have pre-inputted parameter(s) for the second web device 140's current user. In response, the second web device 140 may ask its current user to input parameter(s) using the input interface 142. As an alternative, the second web device 140 may ask its current user to use the first web device 120 to perform steps 205 and 210 first, then use the second web device 140 to perform step 220 again. Thereafter, the second web device 140 can retrieve parameter(s) from the first web device 120. By doing so, the user avoids using the input interface 142, which might be inconvenient to use, to input parameter(s) for the web service.

At step 260, the second web device 140 receives the set of parameter(s) from the first web device 120. At step 265, the second web device 140 applies the set of parameter(s) to the web service for its current user. For example, if the set of parameter(s) includes a username and a password, the second web device 140 automatically logins to the web service for its current user. This means that the user needs not spend time and effort inputting username and password using the input interface 142, which might be inconvenient to use.

Regardless of how the second web device 140 obtains parameter(s) for its user, it can associate the obtained parameter(s) with the second set of biometric characteristic(s) obtained at step 220. For example, this association allows the second web device 140 to apply the associated parameter(s) whenever it obtains another set of biometric characteristic(s) that matches the second set of biometric characteristic(s). Theoretically, this will happen if the user involved in step 220 wants to use the second web device 140 to access the web service again.

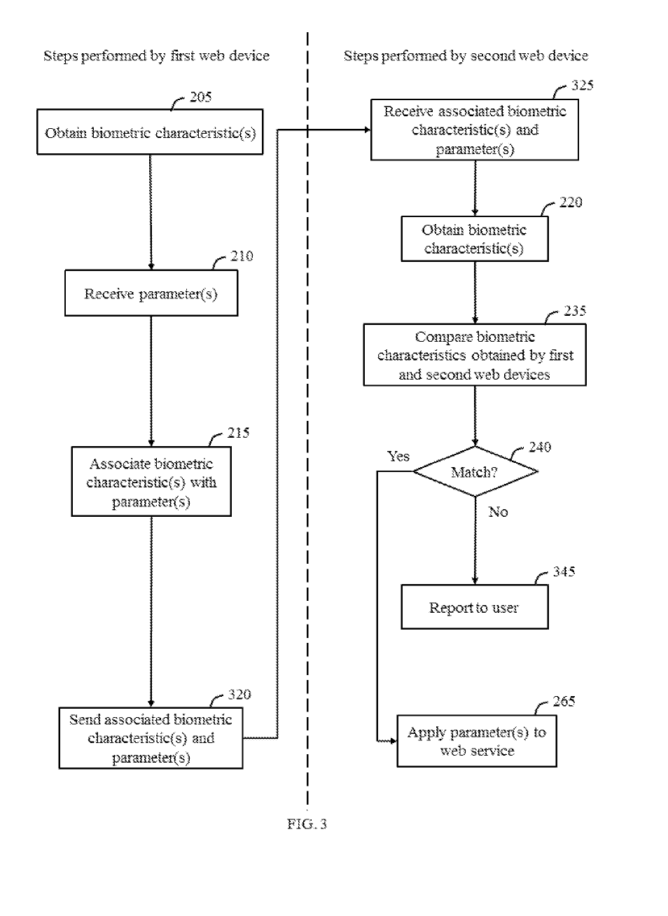

FIG. 3 is a flowchart of another exemplary process performed by the system 100 shown in FIG. 1. Because many of the steps involved in FIG. 3 have counterparts in FIG. 2 that have already been explained, the following paragraphs will illustrate only the differences between these two flowcharts.

Please refer to FIG. 3. At step 320 and step 325, respectively, the first web device 120 sends and the second web device 140 receives the first set of reference biometric characteristic(s) and the set of parameter(s). If the first and second web devices 120 and 140 are two trusted devices within a secured home network, steps 320 and 325 may not arouse much concerns related to information security. But if the environment is not perfectly safe, the system 100 may need to adopt some means to protect private information.

Rather than being performed by the first web device 120, steps 235 and 240 are instead performed by the second web device 140 in FIG. 3. The second web device 140 may use an identification component, which is not depicted in FIG. 1, to perform steps 235 and 240. For example, the identification component can be a dedicated hardware component or be realized by a processor of the second web device 140.

As a result of this arrangement, the user involved in step 220 of FIG. 3 needs not wait for the second web device 140 to communicate with the first web device 120. Furthermore, the user involved in step 220 of FIG. 3 needs not ensure that the first web device 120 is standby to perform steps 235 and 240 when the user is using the second web device 140. Therefore, as long as information security is guaranteed, some people may prefer the process shown in FIG. 3 to the process shown in FIG. 2.

At step 345, the second web device 140 reports to its current user that it does not have pre-inputted parameter(s) for the user. Then, the second web device 140 may ask its user to input parameter(s) for the web service, using the input interface 142. As an alternative, the second web device 140 may ask its user to use the first web device 120 to perform steps 205 and 210 first, then use the second web device 140 to perform step 220 again. Then, the second web device 140 will have pre-entered parameter(s) for the user. By doing so, the user avoids using the input interface 142, which might be inconvenient to use, to input parameter(s).

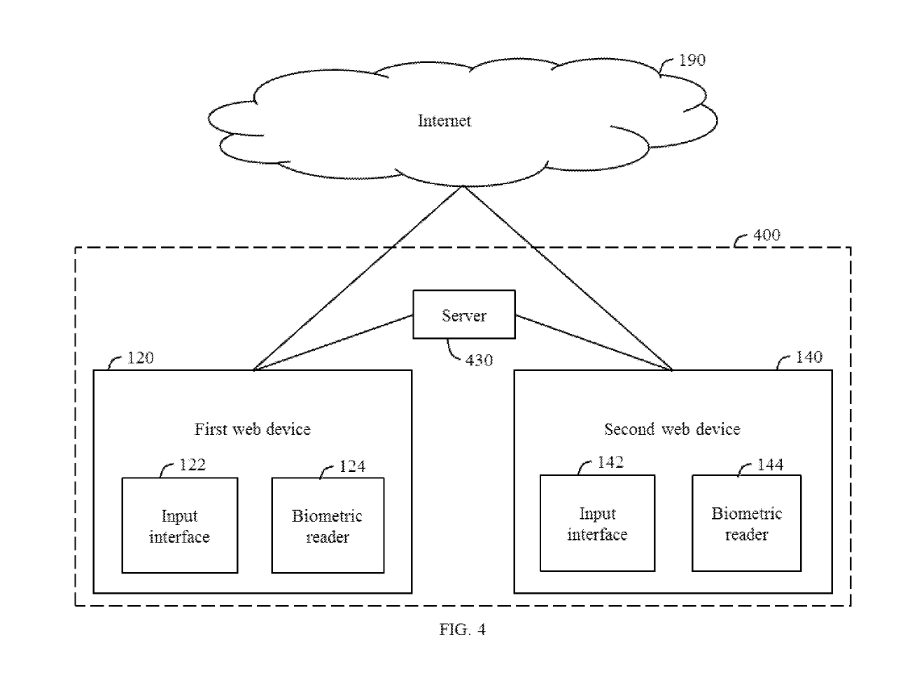

FIG. 4 is a schematic diagram of a system according to another embodiment of the invention. For the sake of simplicity, devices and components that are either unrelated to or only tangentially related to the invention are omitted from FIG. 4. The system 400 shown in FIG. 4 is different from the system 100 shown in FIG. 1 in that the system 400 further includes a server 430. The server 430 is a device that can communicate with the first and second web devices 120 and 140. The server 430 can be located within a LAN where both the first and second web devices 120 and 140 are located, or be located in the Internet 190. The system 400 may need to deal with some concerns related to information security, especially when the server 430 is in the Internet 190.

The server 430 can be a dedicated parameter server or a multifunctional server and one of its functions is to serve as a parameter server. The server 430 serves as an intermediary of the first and second web devices 120 and 140 and takes over some of the responsibility from these two web devices.

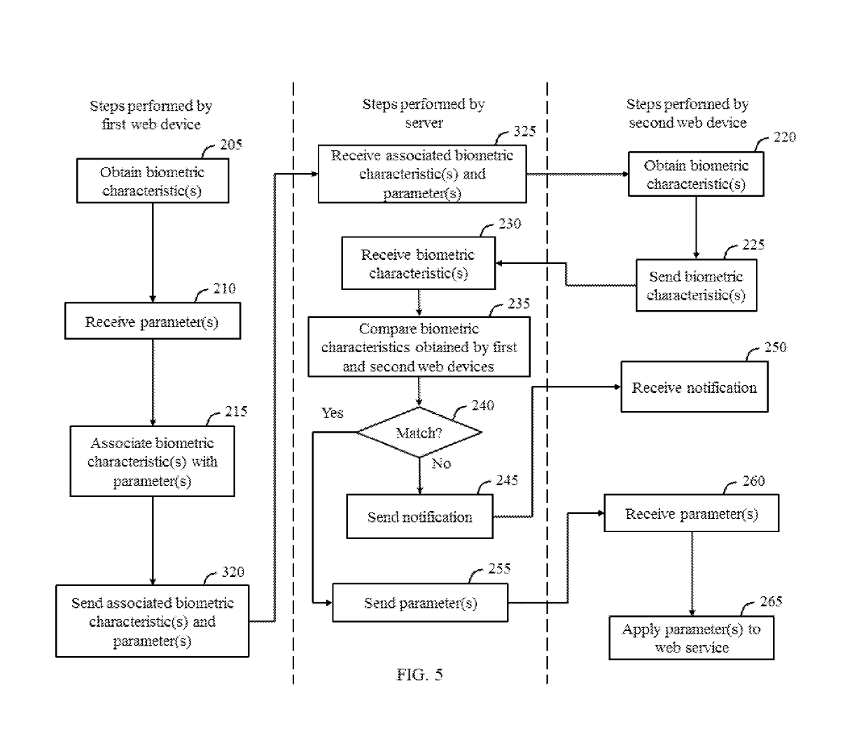

FIG. 5 is a flowchart of an exemplary process performed by the system 400 shown in FIG. 4. For the sake of simplicity, steps that are either unrelated to or only tangentially related to the invention are omitted from FIG. 5. Because many of the steps involved in FIG. 5 have counterparts in FIGS. 2 and 3 that have already been explained, the following paragraphs will illustrate only the differences between FIG. 5 and FIGS. 2 and 3.

Please refer to FIG. 5. At step 320 and step 325, respectively, the first web device 120 sends and the server 430 receives the first set of reference biometric characteristic(s) and the set of parameter(s). After steps 320 and 325, the second web device 140 communicates with the server 430, rather than with the first web device 120, to lookup for already inputted parameter(s). Therefore, unlike FIG. 2, where steps 230, 235, 240, 245, and 255 are performed by the first web device 120, in FIG. 5 these steps are performed by the server 430. Furthermore, unlike FIG. 2, where the second web device 140 communicates with the first web device 120 at steps 225, 250, and 260, in FIG. 5 the second web device 140 communicates with the server 430 at these steps.

In this example, the server 430, rather than the first web device 120, serves as a parameter server. If the second web device 140 does not know which device is the parameter server, at step 225 it can send the second set of biometric characteristic(s) to at least one candidate parameter server, whether the at least one candidate parameter server is within the Internet 190 or a LAN where the second web device 140 belongs to. The address(es) of the candidate parameter server(s) can be provided by the web service, be preset by a manufacturer/vender of the second web device 140, or be preset by a user/owner of the second web device 140. In another example, at step 225 the second web device 140 can broadcast or multicast the second set of biometric characteristic(s) within the aforementioned LAN, to see whether a parameter server is also within the LAN and whether the parameter server can provide the set of parameter(s) inputted at step 210.

The server 430 may use an identification component, which is not depicted in FIG. 4, to perform steps 235 and 240. For example, the identification component can be a dedicated hardware component or be realized by a processor of the server 430.

If the first web device 120, the second web device 140, and the server 430 are all trusted devices within a secured home network, the process shown in FIG. 5 may not arouse much concerns related to information security. But if the environment is not perfectly safe, the system 400 may need to adopt some means to protect private information.

To protect personal information, the systems 100 and 400 may allow their users to decide whether personal information, such as the first set of biometric characteristic(s), the second set of biometric characteristic(s), and the set of parameter(s), can be shared by more than one devices. The processes shown in FIG. 2, FIG. 3, and FIG. 5 are feasible if share of personal information is allowed, at least to some minimal extent.

As this detailed description has shown, the embodiments of the invention can make it more convenient for a user to use a web device to access a web service, especially when the web device does not have a convenient input interface. Furthermore, the embodiments of the invention do save the user's time and effort that would have been spent on inputting the same information for the same web service repetitively on different web devices.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A method for facilitating access of a web service, comprising:
obtaining at least one reference biometric characteristic using a first web device;
receiving at least one parameter for the web service using the first web device;
associating the at least one reference biometric characteristic with the at least one parameter;
obtaining at least one biometric characteristic using a second web device;
comparing the at least one biometric characteristic obtained by the second web device with the at least one reference biometric characteristic; and
applying the at least one parameter to the web service on the second web device if the at least one biometric characteristic obtained by the second web device matches the at least one reference biometric characteristic.

2. The method of claim 1, wherein the step of comparing is performed by the first web device, and the method further comprises:
sending the at least one biometric characteristic obtained by the second web device from the second web device to the first web device; and
sending the at least one parameter from the first web device to the second web device if the at least one biometric characteristic obtained by the second web device matches the at least one reference biometric characteristic.

3. The method of claim 1, wherein the step of comparing is performed by the second web device, and the method further comprises:
sending the at least one reference biometric characteristic and the at least one parameter from the first web device to the second web device.

4. The method of claim 1, wherein the step of comparing is performed by a server, and the method further comprises:
sending the at least one reference biometric characteristic and the at least one parameter from the first web device to the server;
sending the at least one biometric characteristic obtained by the second web device from the second web device to the server; and
sending the at least one parameter from the server to the second web device if the at least one biometric characteristic obtained by the second web device matches the at least one reference biometric characteristic.

5. The method of claim 1, wherein the at least one parameter comprises a username and a password a user inputs to the first web device to login to the web service.

6. The method of claim 1, wherein the at least one parameter comprises a setting a user inputs to the first web device for the web service.

7. A method for facilitating access of a web service, comprising:
obtaining at least one reference biometric characteristic using a first web device;
receiving at least one parameter for the web service using the first web device;
associating the at least one reference biometric characteristic with the at least one parameter;
receiving at least one biometric characteristic from a second web device;
comparing the at least one biometric characteristic received from the second web device with the at least one reference biometric characteristic; and
sending the at least one parameter to the second web device if the at least one biometric characteristic received from the second web device matches the at least one reference biometric characteristic.

8. The method of claim 7, wherein the steps of obtaining, receiving the at least one parameter, associating, receiving the at least one biometric characteristic, comparing, and sending are performed by the first web device.

9. The method of claim 7, wherein the steps of obtaining, receiving the at least one parameter, and associating are performed by the first web device, the steps of receiving the at least one biometric characteristic, comparing, and sending are performed by a server, and the method further comprises:
sending the at least one reference biometric characteristic and the at least one parameter from the first web device to the server.

10. The method of claim 7, wherein the at least one parameter comprises a username and a password a user inputs to the first web device to login to the web service.

11. The method of claim 7, wherein the at least one parameter comprises a setting a user inputs to the first web device for the web service.

12. A method for facilitating access of a web service, comprising:
receiving from a first web device at least one reference biometric characteristic and at least one parameter;
obtaining at least one biometric characteristic using a second web device;
comparing the at least one biometric characteristic obtained by the second web device with the at least one reference biometric characteristic; and
applying the at least one parameter to the web service using the second web device if the at least one biometric characteristic obtained by the second web device matches the at least one reference biometric characteristic.

13. The method of claim 12, wherein the steps of receiving, obtaining, comparing, and applying are performed by the second web device.

14. The method of claim 12, wherein the steps of obtaining and applying are performed by the second web device, the steps of receiving and comparing are performed by a server, and the method further comprises:
sending the at least one biometric characteristic obtained by the second web device from the second web device to the server; and
sending the at least one parameter from the server to the second web device if the at least one biometric characteristic obtained by the second web device matches the at least one reference biometric characteristic.

15. The method of claim 12, wherein the at least one parameter comprises a username and a password a user inputs to the first web device to login to the web service.

16. The method of claim 12, wherein the at least one parameter comprises a setting a user inputs to the first web device for the web service.

17. A method for facilitating access of a web service, comprising:
receiving at least one reference biometric characteristic and at least one parameter from a first web device;
receiving at least one biometric characteristic from a second web device;
comparing the at least one biometric characteristic received from the second web device with the at least one reference biometric characteristic; and
sending the at least one parameter to the second web device if the at least one biometric characteristic received from the second web device matches the at least one reference biometric characteristic.

18. The method of claim 17, wherein the at least one parameter comprises a username and a password a user inputs to the first web device to login to the web service.

19. The method of claim 17, wherein the at least one parameter comprises a setting a user inputs to the first web device for the web service.

20. A method performed by a web device for facilitating access of a web service, comprising:
obtaining at least one biometric characteristic;
sending out the at least one biometric characteristic;
receiving at least one parameter corresponding to the at least one biometric characteristic; and
applying the at least one parameter to the web service.

21. The method of claim 20, wherein the step of sending out the at least one biometric characteristic comprises:
broadcasting the at least one biometric characteristic within a local area network where the web device belongs to.

22. The method of claim 20, wherein the step of sending out the at least one biometric characteristic comprises:
sending the at least one biometric characteristic to at least one candidate parameter server.
